(19) United States
(12) Patent Application Publication
(10) Pub. No.: US 2021/0333740 A1
(43) Pub. Date: Oct. 28, 2021

(54) IMAGE FORMING APPARATUS WITH SCANNER MOUNTED ON UPPER COVER THEREOF

(71) Applicant: Hewlett-Packard Development Company, L.P., Spring, TX (US)

(72) Inventors: Hyunwoo KIM, Seongnam-si (KR); Yongjae KIM, Seongnam-si (KR)

(21) Appl. No.: 17/281,073

(22) PCT Filed: Oct. 10, 2019
(86) PCT No.: PCT/US2019/055586

§ 371 Date: Mar. 29, 2021

(30) Foreign Application Priority Data
Jan. 17, 2019 (KR) 10-2019-0006104

(51) Int. Cl. G03G 21/16; G03G 15/00

(52) U.S. Cl. CPC G03G 21/1604; H04N 1/1074; H04N 2201/0094; G03G 15/6552

(57) ABSTRACT

An example image forming apparatus includes a printing unit including a fixing device to form an image on a print medium, a housing in which the printing unit is located, and a scanner, to read image information from a document, located above the printing unit in a vertical projected area of the housing with respect to a discharge direction of the print medium discharged from the printing unit so as not to overlap with a heater of the fixing device.

### BACKGROUND

An electrophotographic image forming apparatus forms an electrostatic latent image on the surface of a photoconductor by irradiating the photoconductor with modulated light corresponding to image information, supplies toner to develop the electrostatic latent image into a visible toner image, and transfers the toner image to a print medium to fix the toner image, thereby printing an image on the print medium.

The electrophotographic image forming apparatus may include a scanner for reading image information from a document, and the electrophotographic image forming apparatus including the scanner may be referred to as a multi-function printer.

### BRIEF DESCRIPTION OF DRAWINGS

Various examples will be described below with reference to the accompanying drawings, in which:

FIG. 1 is a perspective view of an image forming apparatus according to an example;

FIG. 2 is a configuration diagram of an image forming apparatus according to an example;

FIG. 3 is a configuration diagram of a developing device according to an example;

FIG. 4 is a perspective view of an image forming apparatus in which an upper cover is rotated to open an opening according to an example;

FIG. 5 is a schematic view of an image forming apparatus showing the vicinity of a loading table according to an example;

FIG. 6 is a perspective view showing a lower surface of a scanner according to an example; and

FIG. 7 is a configuration diagram of an image forming apparatus according to an example.

### DETAILED DESCRIPTION OF EXAMPLES

Hereinafter, examples of an image forming apparatus will be described with reference to the accompanying drawings. The same reference numerals are used to denote the same elements, and repeated descriptions thereof will not be given herein.

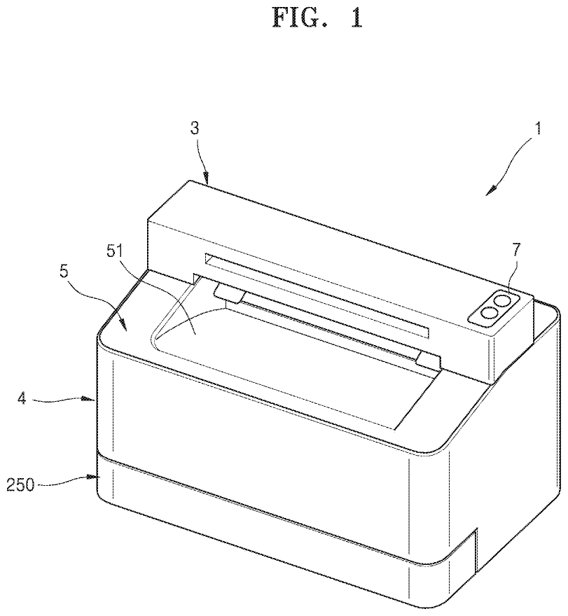

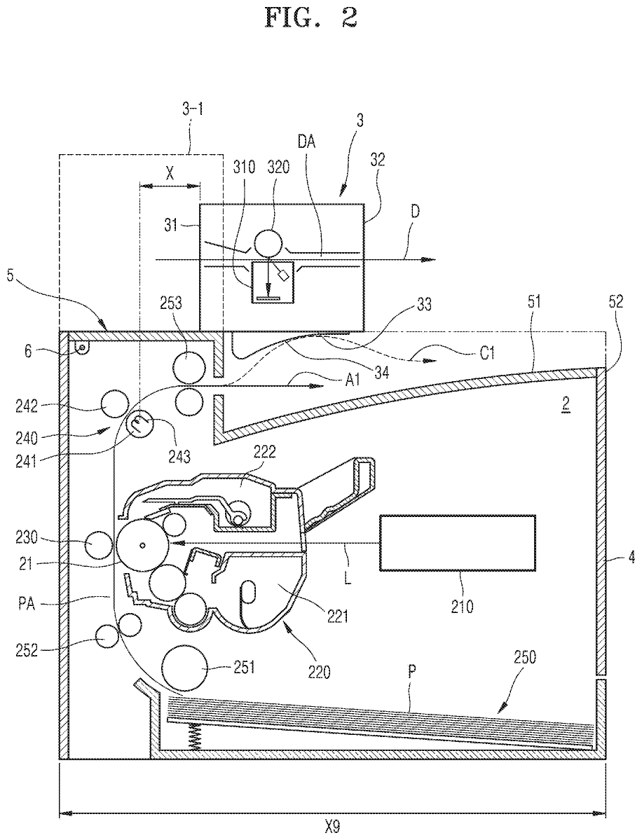

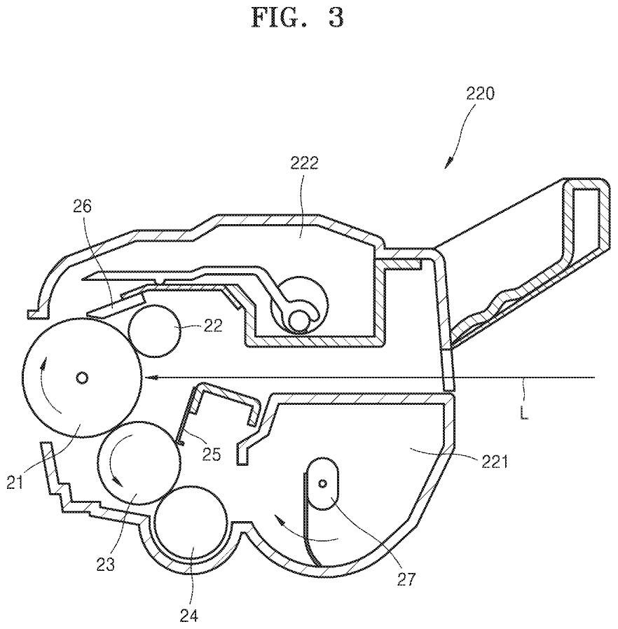

FIG. 1 is a perspective view of an image forming apparatus according to an example. FIG. 2 is a configuration diagram of an image forming apparatus according to an example. FIG. 3 is a configuration diagram of a developing device according to an example.

Referring to FIGS. 1 to 3, an image forming apparatus 1 may include a printing unit 2 and a scanner 3. The image forming apparatus 1 may also be referred to as a multi-function printer. The printing unit 2 may print an image on a print medium P. The scanner 3 may read image information from a document D.

As illustrated in FIG. 2, the printing unit 2 may form an image, using an electrophotographic method, on the print medium P that is transported along a transport path PA. The printing unit 2 may include an exposure device 210 for forming an electrostatic latent image on a photosensitive drum 21, a developing device 220 for supplying toner to the electrostatic latent image to develop the electrostatic latent image into a visible toner image, a transfer device 230 for transferring the toner image to the print medium P transported along the print medium P, and a fixing unit 240 for fixing the toner image to the print medium P.

The developing device 220 accommodates the toner and supplies the toner to the electrostatic latent image formed on the photoconductor (i.e., the photosensitive drum 21) to develop the electrostatic latent image into the visible toner image. The developing device 220 may include the photosensitive drum 21, a charging roller 22, and a developing roller 23. As an example of a photoconductor on which the electrostatic latent image is formed, the photosensitive drum 21 may include a cylindrical metal pipe and a photoconductive layer formed on an outer periphery of the cylindrical metal pipe. The charging roller 22 is an example of a charger that charges a surface of the photosensitive drum 21 to a uniform electric potential. A charging bias voltage is applied to the charging roller 22. A corona charger (not shown) may be employed instead of the charging roller 22. The developing roller 23 supplies the toner accommodated in the developing device 220 to the electrostatic latent image formed on the surface of the photosensitive drum 21 to develop the electrostatic latent image. The described example employs a contact developing method in which the developing roller 23 and the photosensitive drum 21 come into contact with each other to form a developing nip. In this case, the developing roller 23 may include an elastic layer (not shown) formed on an outer periphery of a conductive metal core (not shown). When a developing bias voltage is applied to the developing roller 23, toner is moved and attached to the electrostatic latent image formed on the surface of the photosensitive drum 21 across the developing nip. When a non-contact method is employed, a surface of the developing roller 23 and the surface of the photosensitive drum 21 are spaced apart from each other by an interval of several hundred micrometers.

The developing device 220 may further be provided with a supply roller 24 for adhering toner to the developing roller 23. A supply bias voltage may be applied to the supply roller 24 to adhere toner to the developing roller 23. A regulating member 25 may regulate the amount of toner adhering to the surface of the developing roller 23. The regulating member 25 may be, for example, a regulating blade whose tip is brought into contact with the developing roller 23 at a certain pressure. A cleaning member 26 removes residual toner and foreign materials from the surface of the photosensitive drum 21 before charging. The cleaning member 26 may be, for example, a cleaning blade whose tip is in contact with the surface of the photosensitive drum 21. Hereinafter, the residual toner and foreign materials removed from the surface of the photosensitive drum 21 are referred to as waste toner.

The developing device 220 includes a toner accommodating portion 221 and a waste toner accommodating portion 222. The waste toner accommodating portion 222 accommodates waste toner removed from the surface of the photosensitive drum 21. In the example of FIG. 2, the developing device 220 is a developing device using a one-component developer, and toner is accommodated in the toner accommodating portion 221. The toner accommodating portion 221 may be provided with a stirrer 27. The stirrer 27 transfers the toner to the supply roller 24. The stirrer 27 may also stir toner and charge the toner to a certain electric potential. Although FIG. 2 shows one stirrer 27, the scope of the present disclosure is not limited thereto. A suitable number of stirrers 27 may be provided at appropriate positions in the toner accommodating portion 221 in order to efficiently supply toner to the supply roller 24 considering the volume and shape of the toner accommodating portion 221. The shape of the stirrer 27 may be a shape in which a rotation axis is provided with one or more stirring blades in the form of a flexible film. Also, although not shown in the drawings, the stirrer 27 may be an auger including a spiral stirring blade.

When a two-component developer using toner and a carrier is used as a developer, the toner accommodating portion 221 accommodates a magnetic carrier and toner. In this case, the developing roller 23 may include a rotatable sleeve and a magnet provided inside the sleeve. The carrier is attached to an outer periphery of the developing roller 23 by magnetic force of the magnet and the toner is adhered to the carrier by electrostatic force so that a magnetic brush formed of the carrier and toner is formed on the outer periphery of the developing roller 23. The toner is moved to the electrostatic latent image formed on the photosensitive drum 21 by a developing bias voltage applied to the developing roller 23. The regulating member 25 is located at a certain distance from the surface of the developing roller 23 to regulate a height of the magnetic brush formed on the outer periphery of the developing roller 23. The stirrer 27 stirs the carrier and toner to frictionally charge the toner while transferring the carrier and toner to the developing roller 23.

The exposure device 210 scans the surface of the photosensitive drum 21 charged with a uniform electric potential with light (L) modulated according to the image information. As the exposure device 210, for example, a laser scanning unit (LSU) may be employed, the LSU scanning the photosensitive drum 21 by deflecting light irradiated from a laser diode in a main scanning direction by using, for example, a polygon mirror.

The transfer device 230 may include a feed roller facing the surface of the photosensitive drum 21 to form a transfer nip. A transfer bias voltage for transferring the developed toner image on the surface of the photosensitive drum 21 onto the print medium P is applied to the feed roller. As the transfer device 230, a corona transfer device may be employed instead of the feed roller.

The toner image transferred to a surface of the print medium P by the transfer device 230 is maintained on the surface of the print medium P by electrostatic attraction. The fixing device 240 forms a permanent print image on the print medium P by applying heat and pressure to the toner image and fixing the toner image on the print medium P. The fixing device 240 may include, for example, a heater 241 and a pressing member 242 which are engaged with each other to form a fixing nip. The heater 241 may include a heating element 243 to heat the heater 241. Various types of devices may be employed as the heating element 243 depending on a structure of the fixing device 240. For example, a halogen lamp, a ceramic heater, or the like may be employed as the heating element 243.

An image forming process according to the above-described example will be briefly described. A charging bias voltage is applied to the charging roller 22, and the photosensitive drum 21 is charged to a uniform electric potential. The exposure device 210 scans the photosensitive drum 21 with modulated light corresponding to the image information to form an electrostatic latent image on the surface of the photosensitive drum 21. The toner is transferred by the stirrer 27 to the supply roller 24, and the supply roller 24 attaches the toner to the surface of the developing roller 23. The regulating member 25 forms a toner layer of a uniform thickness on the surface of the developing roller 23. A developing bias voltage is applied to the developing roller 23. The toner transferred to the developing nip as the developing roller 23 is rotated is moved towards and adhered to the electrostatic latent image formed on the surface of the photosensitive drum 21 by the developing bias voltage so that a visible toner image is formed on the surface of the photosensitive drum 21.

The print medium P drawn out from a feeding unit 250 by a pickup roller 251 is transported along the transport path PA. The print medium P is transported by a feed roller 252 to the transfer nip where the transfer device 230 and the photosensitive drum 21 face each other. When a transfer bias voltage is applied to the transfer device 230, the toner image is transferred to the print medium P by electrostatic attraction. The toner image transferred to the print medium P is fixed to the print medium P by receiving heat and pressure from the fixing device 240, whereby printing is completed. The print medium P is discharged by a discharge roller 253. The toner remaining on the surface of the photosensitive drum 21 without being transferred to the print medium P is removed by the cleaning member 26 and is accommodated in the waste toner accommodation portion 222.

The scanner 3 may include an image sensor 310 for reading image information from the document D conveyed along a document transport path DA. The image sensor 310 irradiates light onto the document D and receives light reflected from the document D. The image sensor 310 may include a photoelectric conversion element that photoelectrically converts received light and converts an optical signal into an electric signal. The image sensor 310 may include, for example, a contact image sensor (CIS), a charged-coupled device (CCD), or the like. The image sensor 310 may be a one-dimensional sensor extending in a main scanning direction, that is, in a width direction of the document D. In order to obtain two-dimensional image information, the document D is moved in a sub-scanning direction, that is, in a longitudinal direction. As another example, the document D may be located at a fixed position and the image sensor 310 may be moved in a sub-scanning direction. This type of scanner 3 is referred to as a flat-bed type scanner. The scanner 3 of the illustrated example is a bar-type scanner in which the image sensor 310 is located at a fixed position and the document D is moved in the sub-scanning direction. This type of scanner 3 may be implemented in a simpler structure and a smaller size as compared with the flat-bed type scanner.

A feed roller 320 forms a reading nip facing a contact window of the image sensor 310. The feed roller 320 may bring the document D in contact with a reading window of the image sensor 310. The feed roller 320 may transfer the document D while being pressed against the image sensor 310 and rotated. Although not shown in the drawings, a supply roller for guiding the document D to the reading nip may be on an upstream side of the reading nip, and a discharge roller for discharging the document D may be on a downstream side of the reading nip. Although not shown in the drawings, an automatic document feeder (ADF) for separating a plurality of documents D one by one and transferring them to the reading nip may be on the upstream side of the reading nip.

The image information read from the document D by the scanner 3 may be transmitted to the printing unit 2 and printed on the print medium P. The image forming apparatus 1 may include a line controller (not shown) that transmits the image information read from the document D using the scanner 3 through a communication device, such as a telephone line. The image information read from the document D using the scanner 3 may be transmitted to a host (not shown). With this configuration, it is possible to implement a multi-function printer having a printing function, a copying function, a facsimile function, and an image scanning function.

Referring to FIGS. 1 and 2, the printing unit 2 is located in a housing 4. The housing 4 may have a minimum size to accommodate the printing unit 2. For example, a vertical projected area of the housing 4 may be the same as an area in a case where the scanner 3 is not provided. An opening (not shown) may be provided in an upper portion of the housing 4. An upper cover 5 may open and close the opening. For example, the upper cover 5 may be rotated about a hinge 6 to open and close the opening. In an example, a location of the scanner 3 is optimized in the image forming apparatus 1 in which the scanner 3 is above the printing unit 2.

The printing unit 2 for forming an image on the print medium P by an electrophotographic method is provided with the fixing device 240. The fixing device 240 fixes a toner image on the print medium P by heat and pressure as described above. An operating temperature of the fixing device 240 is, for example, about 160 to 200° C. The heat generated in the fixing device 240 may affect the scanner 3. For example, the image sensor 310 may deteriorate in performance when exposed to a high temperature. Therefore, an appropriate distance is required between the fixing device 240 and the scanner 3.

Referring to FIGS. 1 and 2, an example printing unit 2 forms an image on the print medium P transported along the C-shaped transport path PA. The feeding unit 250 is located below the printing unit 2, the print medium P is transported from a lower portion of the printing unit 2 to an upper portion thereof along the C-shaped transport path PA, and the print medium P on which printing has been completed is discharged to an upper portion of the printing unit 2. The print medium P, on which the printing has been completed, is loaded on a loading table 51 at the upper portion of the printing unit 2. The loading table 51 may be provided on the upper cover 5.

The fixing device 240 is located on a downstream side of the C-shaped transport path PA, and therefore, is located close to the scanner 3 at the upper portion of the printing unit 2. The scanner 3 may be above the fixing device 240 and spaced upward from the fixing device 240 as shown by dashed lines 3-1 in FIG. 2 to secure an appropriate distance between the fixing device 240 and the scanner 3. In this case, a total height of the image forming apparatus 1 may be increased. The scanner 3 may be arranged outside a vertical projected area of the housing 4 in order to secure the appropriate distance between the fixing device 240 and the scanner 3. In this case, a footprint of the image forming apparatus 1 is increased.

In order to reduce or minimize the footprint of the image forming apparatus 1, the scanner 3 may be located at the upper portion of the printing unit 2, and may be located in a vertical projected area X9 of the housing 4 with reference to a discharge direction A1 of the print medium P discharged from the printing unit 2. Furthermore, the scanner 3 may be located so as not to overlap with the heater 241 of the fixing device 240 in order to secure the appropriate distance between the fixing device 240 and the scanner 3. In an example, the scanner 3 is located to be spaced apart from the heater 241 of the fixing device 240 in the discharge direction A1.

In an example, the scanner 3 includes a first end 31 on the upstream side and a second end 32 on the downstream side with reference to the discharge direction A1 of the print medium P discharged from the printing unit 2. Both the first end 31 and the second end 32 of the scanner 3 are located in the vertical projected area X9 of the housing 4 with respect to the discharge direction A1. The first end 31 is located to be spaced apart from the heater 241 in the discharge direction A1. That is, the first end 31 is located on the downstream side of the heater 241 with respect to the discharge direction A1. When a vertical projected distance between the first end 31 and the heater 241 is X, 0≤X. The heater 241 may take various forms, where X is the vertical projected distance between the first end 31 and the center of the heater 241.

If X is less than 0, operation reliability of the scanner 3 may be degraded because the image sensor 310 may be affected by heat generated in the heater 241. According to an example, by arranging the scanner 3 to be spaced apart from the heater 241 in the discharge direction A1 of the print medium P so that 0≤X, an appropriate distance may be secured between the image sensor 310 and the heater 241 without increasing a dimension (e.g., the total height, the total length, etc.) of the image forming apparatus 1 and the scanner 3 may be stably operated without being affected by the heat of the fixing device 240. In addition, by arranging the scanner 3 in the vertical projected area X9 of the housing 4, it is possible to implement the image forming apparatus 1 incorporating the scanner 3 without increasing the footprint.

The scanner 3 may be installed on the upper cover 5 so as to be located in the vertical projected area X9 of the housing 4 and satisfy 0≤X with respect to the discharge direction A1 of the print medium P. In an example, the scanner 3 is integrated with the upper cover 5, which makes it possible to reduce the number of components of the image forming apparatus 1 and to reduce material cost, and also makes it possible to reduce manufacturing cost and manufacturing defect rate by simplifying a manufacturing process. In an example, the scanner 3 may be formed separate from the upper cover 5 and attached to the upper cover 5.

Referring to FIG. 1, an operation panel 7 may be provided for interfacing between the image forming apparatus 1 and a user, and may include at least one input unit, for example, an input button, a touch screen, or the like. The operation panel 7 may include, for example, a display. The operation panel 7 may be located on an upper surface of the scanner 3. Although not shown in the drawings, the operation panel 7 may be located on the upper surface of the upper cover 5 so as not to overlap with the loading table 51.

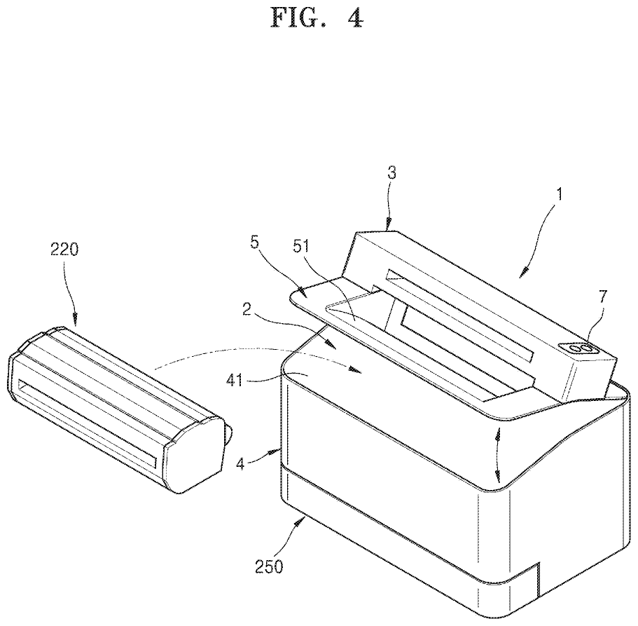

FIG. 4 is a perspective view of an image forming apparatus in which an upper cover is rotated to open an opening according to an example.

Referring to FIG. 4, the developing device 220 may be detachably attached to the printing unit 2 and accessible through an opening 41. When the scanner 3 is arranged at a position beyond the vertical projected area X9 of the housing 4, the scanner 3 and the upper cover 5 are likely to rotate individually with respect to the printing unit 2 in order to open the opening 41. In this case, a structure of the image forming apparatus 1 may be complicated. Since the scanner 3 and the upper cover 5 need to be separately rotated when the opening 41 is opened, such as to attach and detach the developing device 220 to and from the printing unit 2, to address a jam problem, or the like, it may be cumbersome for users.

According to an example, the scanner 3 is installed in the upper cover 5 so as to be located in the vertical projected area X9 of the housing 4. In order to attach and detach the developing device 220, when the upper cover 5 is rotated, the scanner 3 is also rotated with the upper cover 5, and the opening 41 is opened. Therefore, user convenience in the process of attaching/detaching the developing cartridge 220 may be improved. Further, since the inside of the printing unit 2 is exposed to the outside by the operation of rotating the upper cover 5, a user may easily access the inside of the printing unit 2 to address a jam problem or the like.

Referring again to FIG. 2, the scanner 3 is above the loading table 51 and a lower surface 33 of the scanner 3 at least partially faces the loading table 51. The lower surface 33 of the scanner 3 forms a discharge path of the print medium P together with the loading table 51. The lower surface 33 of the scanner 3 may function as an upper guide of the print medium P discharged from the printing unit 2.

In an example, a distance may be X≤100 mm. If X is greater than 100 mm, a length of the print medium P, which is discharged from the printing unit 2, guided by the lower surface 33 of the scanner 3 becomes excessively long and a jam may occur in the print medium P in the discharge process. There is also a possibility that the second end 32 of the scanner 3 is out of the vertical projected area X9 of the housing 4. The influence of the heat of the fixing device 240 on the scanner 3 and the possibility of jamming of the print medium P may be reduced under the condition of 0≤X≤100 mm. At the same time, it is easy to arrange the scanner 3 in the vertical projected area X9 of the housing 4 and the increase in the footprint of the image forming apparatus 1 may be reduced or prevented.

A structure in which the second end 32 of the scanner 3 is located inside an end 52 of the loading table 51 in the discharge direction A1 may be easily secured under the condition of X≤100 mm. With this configuration, an area between the second end 32 of the scanner 3 and the end 52 of the loading table 51 in an upper area of the loading table 51 is open, and thus, a user may easily access the print medium P loaded on the loading table 51.

A structure in which the scanner 3 is located at approximately the center of the vertical projected area X9 of the housing 4 may be realized under the condition of 0≤X≤100 mm. The scanner 3 may be operated in the vertical projected area X9 of the housing 4, and a use space of the image forming apparatus 1 may be reduced or minimized.

The lower surface 33 of the scanner 3 partially faces the loading table 51 under the condition of 0≤X≤100 mm. Therefore, when moisture in the print medium P is evaporated by heat received from the fixing device 240 in a fixing process, water vapor is covered by the scanner 3 and is not visible from the outside. Thus, the problem of mistaking the water vapor as smoke, such as smoke caused by ignition, may be reduced or prevented.

The lower surface 33 of the scanner 3 may be provided with a structure for reducing contact resistance with the print medium P. As an example, a plurality of guide ribs 34 protruding downward toward the loading table 51 and extending in the discharge direction A1 of the print medium P to guide the print medium P may be formed on the lower surface 33 of the scanner 3. The plurality of guide ribs 34 may be arranged in a width direction of the print medium P. The print medium P may be guided by the guide ribs 34 and stably discharged from the printing unit 2 to the loading table 51. Even when a curl or the like is generated on the print medium P and the print medium P is curved upward and discharged as indicated by C1 in FIG. 2, the print medium P is guided by the guide ribs 34 and is not caught by the lower surface 33 of the scanner 3. Therefore, it is possible to reduce a problem of a jam at the time of discharging and damage to the print medium P caused thereby.

The moisture in the print medium P may be evaporated by the heat received from the fixing device 240 in the fixing process. The evaporated moisture may be condensed and attach to the lower surface 33 of the scanner 3 or the guide ribs 34 and then attach to the print medium P to contaminate the print medium P.

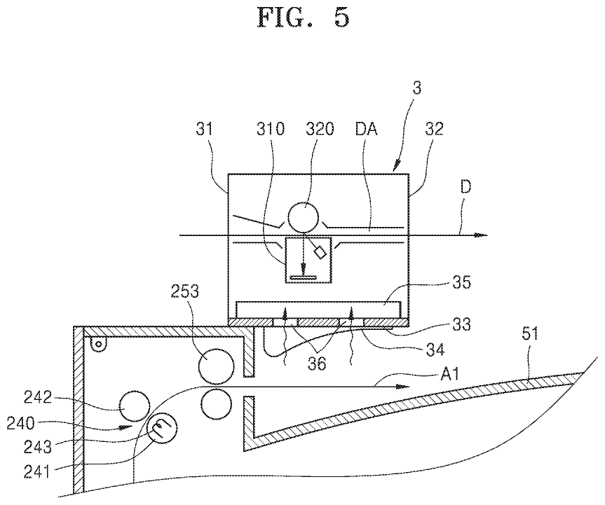

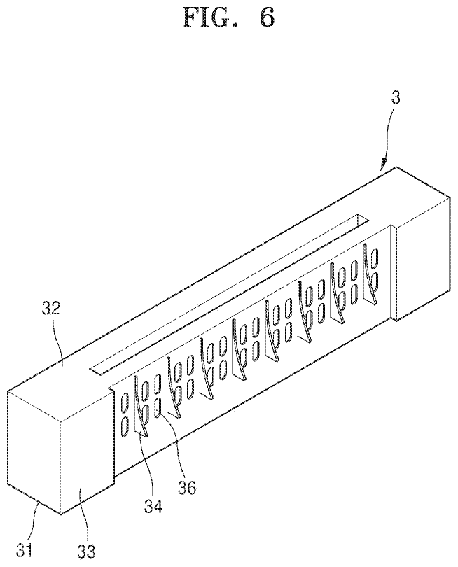

FIG. 5 is a schematic view of an image forming apparatus showing the vicinity of a loading table according to an example. FIG. 6 is a perspective view showing a lower surface of a scanner according to an example.

Referring to FIGS. 5 and 6, a condensation chamber 35 may be provided in the scanner 3. The lower surface 33 of the scanner 3 may be provided with a communication hole 36 connected to the condensation chamber 35. For example, the plurality of guide ribs 34 may be provided in a width direction on the lower surface 33 of the scanner 3, and the communication hole 36 may be provided between the guide ribs 34 to penetrate the lower surface 33 and to communicate the condensation chamber 35 with the outside.

With this configuration, water vapor evaporated from the discharged print medium P is drawn into the condensation chamber 35 through the communication hole 36. The water vapor condenses in the condensation chamber 35. Therefore, contamination of the print medium P by the condensed water may be reduced or prevented. Further, since the water vapor is drawn into the condensation chamber 35, visibility of the water vapor is reduced. Thus, the problem of mistaking the water vapor as smoke caused by ignition may be reduced or prevented.

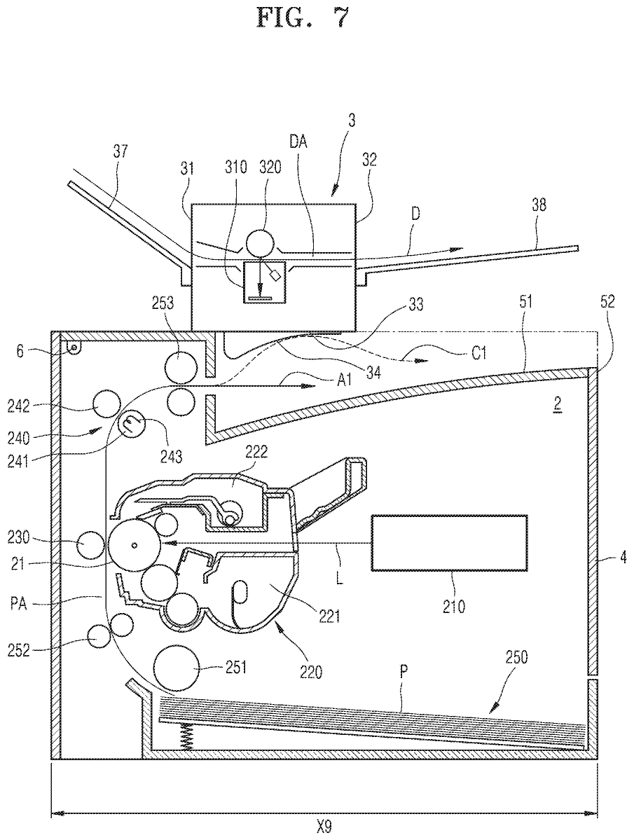

FIG. 7 is a configuration diagram of an image forming apparatus according to an example.

Referring to FIG. 7, the image forming apparatus may include an inlet guide 37 for guiding the document D to be scanned to the scanner 3. A user may insert the document D into the document transport path DA of the scanner 3 along the inlet guide 37. Although not shown, when the above-described ADF is employed, the plurality of documents D to be scanned are loaded on the inlet guide 37. The ADF may successively take out the documents D one by one from the plurality of documents D and transfer them to the reading nip.

The inlet guide 37 may be located in the vertical projected area of the housing 4. That is, the installation angle and length of the inlet guide 37 may be determined such that the inlet guide 37 is entirely located in the vertical projected area of the housing 4. With this configuration, an increase in the footprint of the image forming apparatus 1 may be reduced or prevented.

The image forming apparatus 1 may include a discharge guide 38 for guiding the document D discharged from the scanner 3 after being scanned. The scanned document D may be loaded on the discharge guide 38. By using the discharge guide 38, it is possible to prevent the document D from falling onto the loading table 51 and mixing with the print medium P.

The discharge guide 38 may be located in the vertical projected area of the housing 4. That is, the installation angle and length of the discharge guide 38 may be determined such that the discharge guide 38 is entirely located in the vertical projected area of the housing 4. With this configuration, an increase in the footprint of the image forming apparatus 1 may be reduced or prevented.

In the above examples, it has been described that the scanner 3, the inlet guide 37, and the discharge guide 38 are located in the vertical projected area of the housing 4. The vertical projected area of the housing 4 may be substantially the same as the vertical projected area of the printing unit 2 since the housing 4 has the minimum size in which the printing unit 2 is accommodated.

A transfer direction of the document D is the same as the discharge direction A1 of the print medium P in the above-described examples but may be opposite to the discharge direction A1 of the print medium P. In the example of FIG. 7, the inlet guide 37 may be regarded as a discharge guide, and the discharge guide 38 may be regarded as an inlet guide.

It should be understood that the present disclosure described herein should be considered in a descriptive sense only and not for purposes of limitation. Descriptions of features or aspects within each example should typically be considered as available for other similar features or aspects in other examples. Therefore, the scope of the present disclosure is defined not by the description of the present disclosure but by the appended claims.

What is claimed is:

1. An image forming apparatus comprising:
a printing unit comprising a fixing device to form an image on a print medium;
a housing in which the printing unit is located; and
a scanner to read image information from a document,
wherein the scanner is located above the printing unit in a vertical projected area of the housing with respect to a discharge direction of the print medium discharged from the printing unit so as not to overlap with a heater of the fixing device.

2. The image forming apparatus of claim 1,
wherein the scanner comprises a first end on an upstream side and a second end on a downstream side with respect to the discharge direction, and
wherein the first end is located on a downstream side of the heater with respect to the discharge direction and 0≤X, where X is a vertical projected distance between the first end and the heater.

3. The image forming apparatus of claim 2, wherein X≤100 mm.

4. The image forming apparatus of claim 1, further comprising:
an opening provided in the housing for accessing the printing unit; and
an upper cover to open and close the opening,
wherein the scanner is installed on the upper cover.

5. The image forming apparatus of claim 4,
wherein the printing unit comprises a developing device to accommodate toner and to supply the toner to an electrostatic latent image formed on a photoconductor to develop the electrostatic latent image into a visible toner image, and
wherein the developing device is detachably attached to the printing unit through the opening.

6. The image forming apparatus of claim 4,
wherein the upper cover is provided with a loading table to load the print medium discharged from the printing unit, and
wherein a lower surface of the scanner at least partially faces the loading table.

7. The image forming apparatus of claim 6, further comprising:
a plurality of guide ribs protruding downward from the lower surface of the scanner and extending in the discharge direction of the print medium to guide the print medium.

8. The image forming apparatus of claim 6,
wherein the scanner comprises a condensation chamber, and
wherein a communication hole connected to the condensation chamber is provided on the lower surface of the scanner.

9. The image forming apparatus of claim 4, further comprising:
an inlet guide to guide a document to be scanned to the scanner; and
a discharge guide to guide a document scanned and discharged from the scanner,
wherein the inlet guide and the discharge guide are in the vertical projected area of the housing.

10. An image forming apparatus comprising:
a printing unit comprising a fixing device having a heater to form an image on a print medium;
a housing in which the printing unit is located, the housing comprising an opening at an upper portion of the housing;
an upper cover to open and close the opening, the upper cover comprising a loading table to load the print medium discharged from the printing unit; and
a scanner, to read image information from a document, installed above the upper cover such that at least a part of a lower surface of the scanner faces the loading table and forms a discharge path of the print medium, the scanner located in a vertical projected area of the housing,
wherein the scanner comprises a first end on an upstream side and a second end on a downstream side with respect to a discharge direction of the print medium, and
wherein the first end is spaced apart from the heater in the discharge direction and 0≤X≤100 mm, where X is a vertical projected distance between the first end and the heater.

11. The image forming apparatus of claim 10,
wherein the printing unit comprises a developing device to accommodate toner and to supply the toner to an electrostatic latent image formed on a photoconductor to develop the electrostatic latent image into a visible toner image, and
wherein the developing device is detachably attached to the printing unit through the opening.

12. The image forming apparatus of claim 10, further comprising:
a plurality of guide ribs protruding downward from the lower surface of the scanner and extending in the discharge direction of the print medium to guide the print medium.

13. The image forming apparatus of claim 10,
wherein the scanner comprises a condensation chamber, and
wherein a communication hole connected to the condensation chamber is provided on the lower surface of the scanner.

14. The image forming apparatus of claim 10, further comprising:
an inlet guide to guide a document to be scanned to the scanner; and
a discharge guide to guide a document scanned and discharged from the scanner,
wherein the inlet guide and the discharge guide are in a vertical projected area of the housing.

15. The image forming apparatus of claim 10, wherein a transfer direction of the document is the same as a transfer direction of the print medium.
